(19) United States
(12) Patent Application Publication
(10) Pub. No.: US 2024/0362520 A1
(43) Pub. Date: Oct. 31, 2024

(54) METHOD AND SYSTEM FOR PROVIDING CANONICAL DATA MODELS

(71) Applicant: JPMorgan Chase Bank, N.A., New York, NY (US)

(72) Inventors: Chandra GORANTLA, Sugar Land, TX (US); Sumit KHANNA, East Windsor, NJ (US); Alexander BOTTA, Teaneck, NJ (US); Karen FUNG, Jersey City, NJ (US); Kevin FUNG, Warren, NJ (US)

(73) Assignee: JPMorgan Chase Bank, N.A., New York, NY (US)

(21) Appl. No.: 18/139,685

(22) Filed: Apr. 26, 2023

(51) Int. Cl. G06N 20/00

(52) U.S. Cl. CPC G06N 20/00

(57) ABSTRACT

A method for providing a canonical data model is disclosed. The method includes receiving, via a graphical user interface, requests to generate machine learning models, the requests including configuration data for the machine learning models; identifying the canonical data model that corresponds to the requested machine learning models, the canonical data model including various predetermined parameters; automatically mapping the configuration data to the various predetermined parameters; automatically generating the machine learning models based on a result of the mapping; and outputting the machine learning models in response to the requests.

### BACKGROUND

### 1. Field of the Disclosure

This technology generally relates to methods and systems for providing standard data models, and more particularly to methods and systems for providing standardized data models to facilitate automatic generating and mapping of applications in a networked environment.

### 2. Background Information

Many business entities utilize a variety of data models to facilitate operational activities and to provide services for users. Often, these data models must be mapped to various applications and numerous interface components to enable communication of data in a networked environment. Historically, implementations of conventional data model management techniques have resulted in varying degrees of success with respect to effective and efficient communication in the networked environment.

One drawback of using the conventional data model management techniques is that in many instances, certain data models such as, for example, margin data models are complex and require accurate mapping of numerous data fields with various computing components for proper operation. As a result, generation and management of these data models are very resource intensive activities. Additionally, these data models are not standardized across different implementations which result in confusion and inaccurate mapping of similar fields between applications due to the complexity.

Therefore, there is a need to provide a unified data model such as, for example, a canonical data model to standardize the entities and columns for sharing between applications and various interfaces to enable automated code generation, ensure consistency across different applications, and provide improved visibility for users.

### SUMMARY

The present disclosure, through one or more of its various aspects, embodiments, and/or specific features or sub-components, provides, inter alia, various systems, servers, devices, methods, media, programs, and platforms for providing standardized data models to facilitate automatic generating and mapping of applications in a networked environment.

According to an aspect of the present disclosure, a method for providing a canonical data model is disclosed. The method is implemented by at least one processor. The method may include receiving, via a graphical user interface, at least one request to generate at least one model, the at least one request may include configuration data for the at least one model; identifying the canonical data model that corresponds to the at least one model, the canonical data model may include at least one parameter; automatically mapping the configuration data to the at least one parameter; automatically generating the at least one model based on a result of the mapping; and outputting the at least one model in response to the at least one request.

In accordance with an exemplary embodiment, the canonical data model may relate to a predetermined data model that includes a standardized mapping of a plurality of entities and columns for a plurality of network components, the plurality of network components may include at least one application and at least one application programming interface.

In accordance with an exemplary embodiment, prior to identifying the canonical data model, the method may further include determining, by using the configuration data, whether the requested at least one model corresponds to a previously generated concept; and identifying the canonical data model when the requested at least one model does not correspond to the previously generated concept.

In accordance with an exemplary embodiment, the method may further include identifying a previously generated model that corresponds to the previously generated concept when the requested at least one model corresponds to the previously generated concept; and outputting the previously generated model in response to the at least one request.

In accordance with an exemplary embodiment, to automatically map the configuration data, the method may further include categorizing at least one business context in the configuration data based on the at least one parameter; and determining at least one downstream feed for the at least one model based on the at least one parameter.

In accordance with an exemplary embodiment, the at least one parameter may include standardized terminology for categorizing the at least one business context in the configuration data.

In accordance with an exemplary embodiment, the method may further include determining at least one standard application programming interface configuration for the at least one model based on the at least one parameter; and determining at least one standard integration configuration for the at least one model based on the at least one parameter.

In accordance with an exemplary embodiment, to automatically generate the at least one model, the method may further include automatically generating software code for the at least one model based on the result of the mapping, wherein the automatically generated software code may be operable in a networked environment to access data and to forecast at least one outcome based on the accessed data.

In accordance with an exemplary embodiment, the at least one model may include at least one from among a machine learning model, a mathematical model, a process model, and a data model.

According to an aspect of the present disclosure, a computing device configured to implement an execution of a method for providing a canonical data model is disclosed. The computing device including a processor; a memory; and a communication interface coupled to each of the processor and the memory, wherein the processor may be configured to receive, via a graphical user interface, at least one request to generate at least one model, the at least one request may include configuration data for the at least one model; identify the canonical data model that corresponds to the at least one model, the canonical data model may include at least one parameter; automatically map the configuration data to the at least one parameter; automatically generate the at least one model based on a result of the mapping; and output the at least one model in response to the at least one request.

In accordance with an exemplary embodiment, the canonical data model may relate to a predetermined data model that includes a standardized mapping of a plurality of entities and columns for a plurality of network components, the plurality of network components may include at least one application and at least one application programming interface.

In accordance with an exemplary embodiment, prior to identifying the canonical data model, the processor may be further configured to determine, by using the configuration data, whether the requested at least one model corresponds to a previously generated concept; and identify the canonical data model when the requested at least one model does not correspond to the previously generated concept.

In accordance with an exemplary embodiment, the processor may be further configured to identify a previously generated model that corresponds to the previously generated concept when the requested at least one model corresponds to the previously generated concept; and output the previously generated model in response to the at least one request.

In accordance with an exemplary embodiment, to automatically map the configuration data, the processor may be further configured to categorize at least one business context in the configuration data based on the at least one parameter; and determine at least one downstream feed for the at least one model based on the at least one parameter.

In accordance with an exemplary embodiment, the at least one parameter may include standardized terminology for categorizing the at least one business context in the configuration data.

In accordance with an exemplary embodiment, the processor may be further configured to determine at least one standard application programming interface configuration for the at least one model based on the at least one parameter; and determine at least one standard integration configuration for the at least one model based on the at least one parameter.

In accordance with an exemplary embodiment, to automatically generate the at least one model, the processor may be further configured to automatically generate software code for the at least one model based on the result of the mapping, wherein the automatically generated software code may be operable in a networked environment to access data and to forecast at least one outcome based on the accessed data.

In accordance with an exemplary embodiment, the at least one model may include at least one from among a machine learning model, a mathematical model, a process model, and a data model.

According to an aspect of the present disclosure, a non-transitory computer readable storage medium storing instructions for providing a canonical data model is disclosed. The storage medium including executable code which, when executed by a processor, may cause the processor to receive, via a graphical user interface, at least one request to generate at least one model, the at least one request may include configuration data for the at least one model; identify the canonical data model that corresponds to the at least one model, the canonical data model may include at least one parameter; automatically map the configuration data to the at least one parameter; automatically generate the at least one model based on a result of the mapping; and output the at least one model in response to the at least one request.

In accordance with an exemplary embodiment, the canonical data model may relate to a predetermined data model that includes a standardized mapping of a plurality of entities and columns for a plurality of network components, the plurality of network components may include at least one application and at least one application programming interface.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing standardized data models to facilitate automatic generating and mapping of applications in a networked environment.

FIG. 4 is a flowchart of an exemplary process for implementing a method for providing standardized data models to facilitate automatic generating and mapping of applications in a networked environment.

FIG. 5 is a model and interface diagram of an exemplary process for implementing a method for providing standardized data models to facilitate automatic generating and mapping of applications in a networked environment.

FIG. 6 is a results entity distribution diagram of an exemplary process for implementing a method for providing standardized data models to facilitate automatic generating and mapping of applications in a networked environment.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

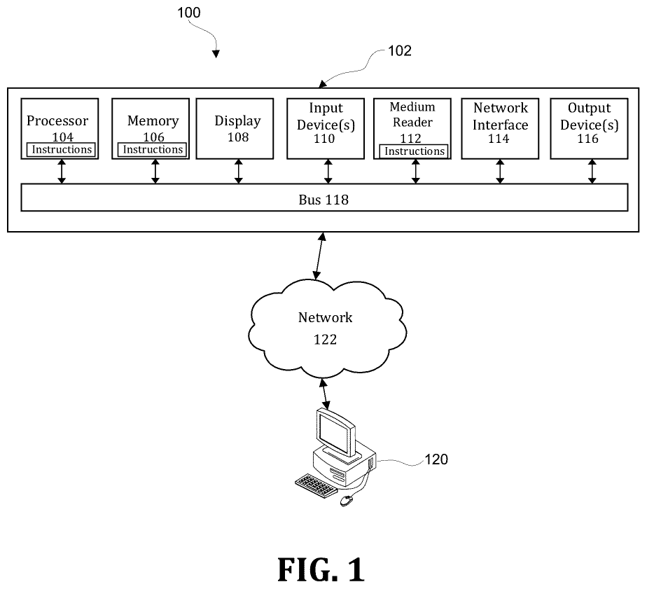

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing standardized data models to facilitate automatic generating and mapping of applications in a networked environment.

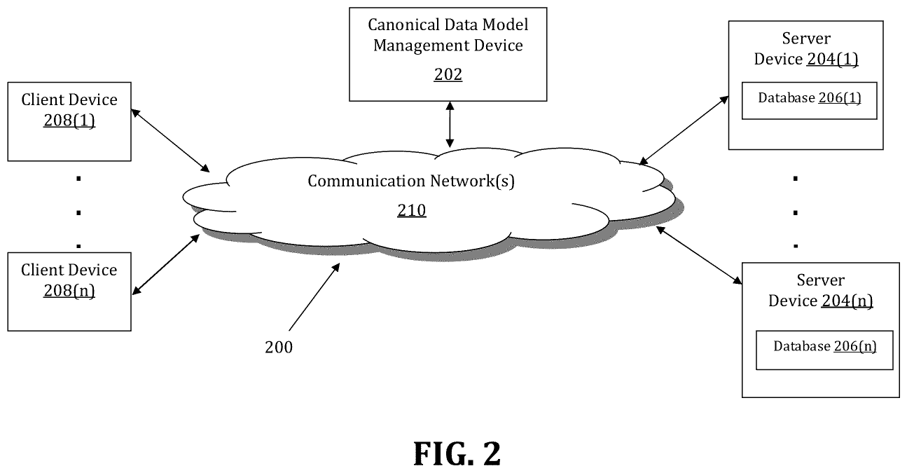

Referring to FIG. 2, a schematic of an exemplary network environment 200 for implementing a method for providing standardized data models to facilitate automatic generating and mapping of applications in a networked environment is illustrated. In an exemplary embodiment, the method is executable on any networked computer platform, such as, for example, a personal computer (PC).

The method for providing standardized data models to facilitate automatic generating and mapping of applications in a networked environment may be implemented by a Canonical Data Model Management (CDMM) device 202. The CDMM device 202 may be the same or similar to the computer system 102 as described with respect to FIG. 1. The CDMM device 202 may store one or more applications that can include executable instructions that, when executed by the CDMM device 202, cause the CDMM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CDMM device 202 itself, may be located in virtual server(s) running in a cloud-based computing environment rather than being tied to one or more specific physical network computing devices. Also, the application(s) may be running in one or more virtual machines (VMs) executing on the CDMM device 202. Additionally, in one or more embodiments of this technology, virtual machine(s) running on the CDMM device 202 may be managed or supervised by a hypervisor.

In the network environment 200 of FIG. 2, the CDMM device 202 is coupled to a plurality of server devices 204(1)-204(n) that hosts a plurality of databases 206(1)-206(n), and also to a plurality of client devices 208(1)-208(n) via communication network(s) 210. A communication interface of the CDMM device 202, such as the network interface 114 of the computer system 102 of FIG. 1, operatively couples and communicates between the CDMM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CDMM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and CDMM devices that efficiently implement a method for providing standardized data models to facilitate automatic generating and mapping of applications in a networked environment.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CDMM device 202 may be a standalone device or integrated with one or more other devices or apparatuses, such as one or more of the server devices 204(1)-204(n), for example. In one particular example, the CDMM device 202 may include or be hosted by one of the server devices 204(1)-204(n), and other arrangements are also possible. Moreover, one or more of the devices of the CDMM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CDMM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to requests, configuration data, models, canonical data models, parameters, entities, contexts, standardized mappings, and unified data models.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CDMM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the CDMM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the CDMM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CDMM device 202, the server devices 204(1)-204(n), or the client devices 208(1)-208(n), for example, may be configured to operate as virtual instances on the same physical machine. In other words, one or more of the CDMM device 202, the server devices 204(1)-204(n), or the client devices 208(1)-208(n) may operate on the same physical device rather than as separate devices communicating through communication network(s) 210. Additionally, there may be more or fewer CDMM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

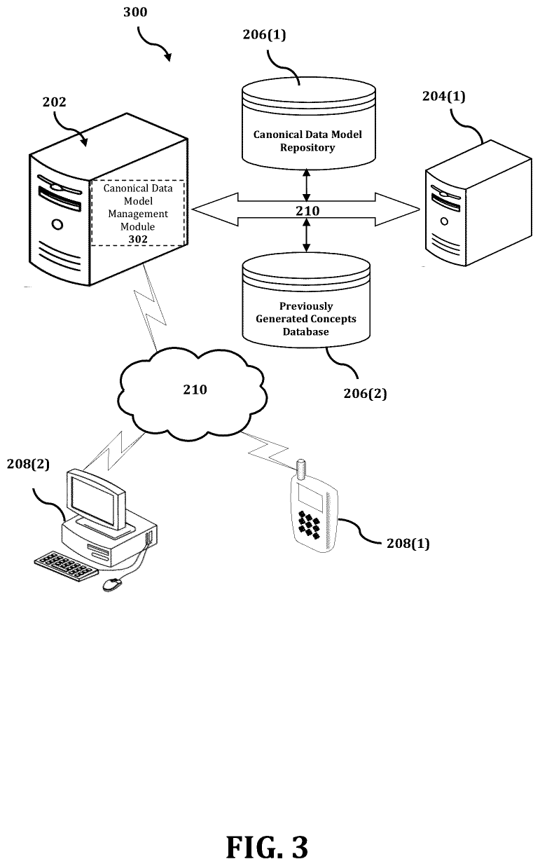

The CDMM device 202 is described and shown in FIG. 3 as including a canonical data model management module 302, although it may include other rules, policies, modules, databases, or applications, for example. As will be described below, the canonical data model management module 302 is configured to implement a method for providing standardized data models to facilitate automatic generating and mapping of applications in a networked environment.

An exemplary process 300 for implementing a mechanism for providing standardized data models to facilitate automatic generating and mapping of applications in a networked environment by utilizing the network environment of FIG. 2 is shown as being executed in FIG. 3. Specifically, a first client device 208(1) and a second client device 208(2) are illustrated as being in communication with CDMM device 202. In this regard, the first client device 208(1) and the second client device 208(2) may be “clients” of the CDMM device 202 and are described herein as such. Nevertheless, it is to be known and understood that the first client device 208(1) and/or the second client device 208(2) need not necessarily be “clients” of the CDMM device 202, or any entity described in association therewith herein. Any additional or alternative relationship may exist between either or both of the first client device 208(1) and the second client device 208(2) and the CDMM device 202, or no relationship may exist.

Further, CDMM device 202 is illustrated as being able to access a canonical data model repository 206(1) and a previously generated concepts database 206(2). The canonical data model management module 302 may be configured to access these databases for implementing a method for providing standardized data models to facilitate automatic generating and mapping of applications in a networked environment.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the CDMM device 202 via broadband or cellular communication. Of course, these embodiments are merely exemplary and are not limiting or exhaustive.

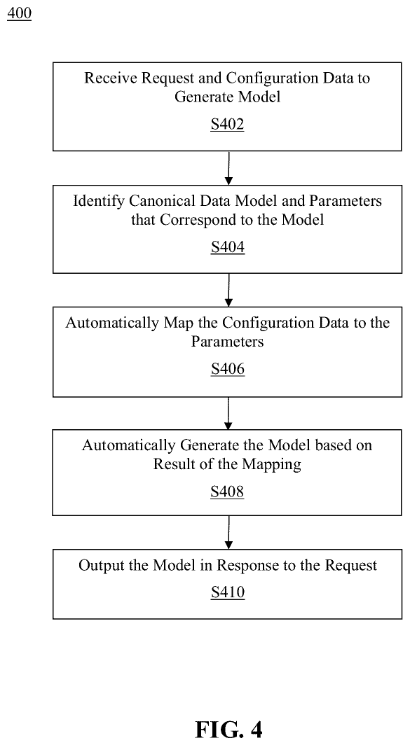

Upon being started, the canonical data model management module 302 executes a process for providing standardized data models to facilitate automatic generating and mapping of applications in a networked environment. An exemplary process for providing standardized data models to facilitate automatic generating and mapping of applications in a networked environment is generally indicated at flowchart 400 in FIG. 4.

In the process 400 of FIG. 4, at step S402, requests to generate models may be received. The requests may be received via a graphical user interface. In an exemplary embodiment, the requests may include configuration data for the requested models. The configuration data may include information that relates to an arrangement and/or set-up of various components of the desired models. For example, a user may design and generate configuration data for a desired margin model, which is then submitted as a request via the graphical user interface.

In another exemplary embodiment, the models may include at least one from among a machine learning model, a mathematical model, a process model, and a data model. The model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

At step S404, canonical data models that correspond to the requested models may be identified. The canonical data models may include various parameters. In an exemplary embodiment, the canonical data model may relate to a predetermined data model that includes a standardized mapping of entities and columns for a plurality of network components. The plurality of network components may include applications and corresponding application programming interfaces (APIs).

In another exemplary embodiment, prior to identifying the canonical data models, an action may be initiated to determine whether concepts that are associated with the requested models already exist in a repository, or whether new concepts are required. The action may include determining whether the requested models correspond to previously generated concepts. The configuration data in the requests may be usable to make the determination. Then, the canonical data models may be identified when the requested models do not correspond to the previously generated concepts.

Alternatively, in another exemplary embodiment, previously generated models that correspond to the previously generated concepts may be identified. The previously generated models may be identified when the requested models correspond to the previously generated concepts. Then, the identified previously generated models may be outputted in response to the requests. The identified previously generated models may be outputted consistent with present disclosures.

In another exemplary embodiment, the applications may include at least one from among a monolithic application and a microservice application. The monolithic application may describe a single-tiered software application where the user interface and data access code are combined into a single program from a single platform. The monolithic application may be self-contained and independent from other computing applications.

In another exemplary embodiment, a microservice application may include a unique service and a unique process that communicates with other services and processes over a network to fulfill a goal. The microservice application may be independently deployable and organized around business capabilities. In another exemplary embodiment, the microservices may relate to a software development architecture such as, for example, an event-driven architecture made up of event producers and event consumers in a loosely coupled choreography. The event producer may detect or sense an event such as, for example, a significant occurrence or change in state for system hardware or software and represent the event as a message. The event message may then be transmitted to the event consumer via event channels for processing.

In another exemplary embodiment, the event-driven architecture may include a distributed data streaming platform such as, for example, an APACHE KAFKA platform for the publishing, subscribing, storing, and processing of event streams in real time. As will be appreciated by a person of ordinary skill in the art, each microservice in a microservice choreography may perform corresponding actions independently and may not require any external instructions.

In another exemplary embodiment, microservices may relate to a software development architecture such as, for example, a service-oriented architecture which arranges a complex application as a collection of coupled modular services. The modular services may include small, independently versioned, and scalable customer-focused services with specific business goals. The services may communicate with other services over standard protocols with well-defined interfaces. In another exemplary embodiment, the microservices may utilize technology-agnostic communication protocols such as, for example, a Hypertext Transfer Protocol (HTTP) to communicate over a network and may be implemented by using different programming languages, databases, hardware environments, and software environments.

At step S406, the configuration data may be automatically mapped to the parameters. In an exemplary embodiment, the automated mapping may relate to a process of matching data fields from the configuration data to the parameters. A data element mapping may be generated to represent the relationship between the various data fields in the configuration data and the parameters. Consistent with present disclosure, the automated matching process may be accomplished without additional intervention from users.

In another exemplary embodiment, automatically mapping the configuration data may include categorizing business contexts in the configuration data based on the parameters. The parameters may include standardized terminology for categorizing the business contexts in the configuration data. Further, downstream feeds for the requested models may be determined. The downstream feeds may be determined based on the parameters consistent with present disclosures.

Additionally, in another exemplary embodiment, automatically mapping the configuration data may include determining standard application programming interface (API) configurations for the requested models. The standard API configurations may be determined based on the parameters. Further, standard integration configurations for the requested models may also be determined. The standard integration configurations may be determined based on the parameters consistent with present disclosures.

At step S408, the requested models may be automatically generated based on a result of the mapping. In an exemplary embodiment, automatically generating the requested models may include automatically generating software codes for the requested models. The software codes may be automatically generated based on a result of the mapping. Consistent with present disclosure, the automated generating process may be accomplished without additional intervention from users.

In another exemplary embodiment, the automatically generated software code may be operable in a networked environment to access data. For example, an automatically generated margin model may include various API mappings that facilitate the aggregation of data to enable predictive operations. Then, the automatically generated software code may be usable to forecast various outcomes based on the accessed data.

At step S410, the automatically generated models may be outputted in response to the requests. In an exemplary embodiment, the automatically generated models may be persisted in a repository. A location identifier that provides a destination path to the automatically generated models may be provided in response to the requests. For example, a destination path to the location where the automatically generated models are persisted in the repository may be provided together with a notification in response to the requests.

In another exemplary embodiment, the notification may be generated when the models are automatically generated. The notification may provide information that relates to the automatically generated models such as, for example, a completion status as well as information that relates to the canonical data model used and a result of the automated mapping. In another exemplary embodiment, documentation such as, for example, a log may be generated together with the automatically generated models. The documentation may include information that relates to the automatically generated models, the canonical data model used, and a result of the automated mapping.

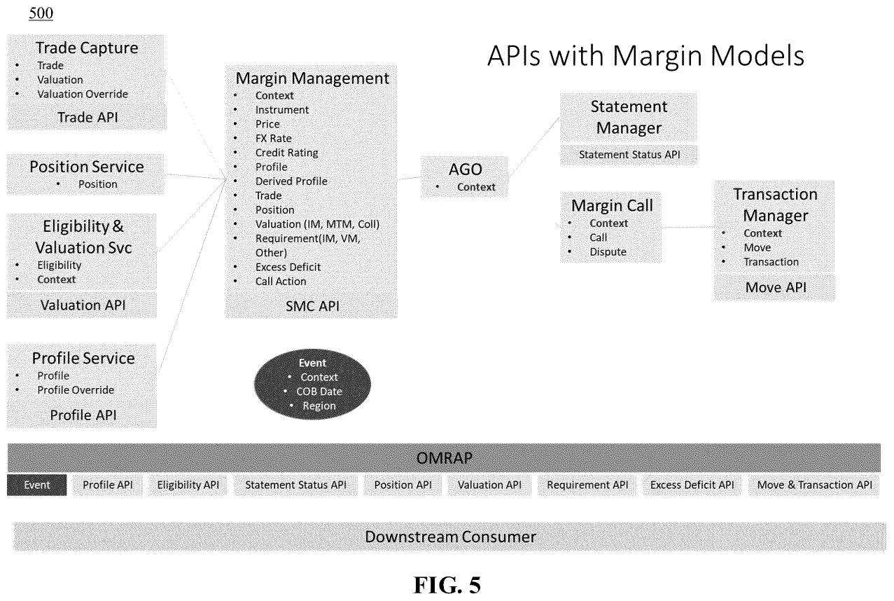

FIG. 5 is a model and interface diagram 500 of an exemplary process for implementing a method for providing standardized data models to facilitate automatic generating and mapping of applications in a networked environment. In FIG. 5, an exemplary mapping of application programming interfaces (APIs) with machine learning models such as, for example, margin models is provided. The mapping may facilitate the sharing of standardized entities and columns between applications and the APIs.

As illustrated in FIG. 5, various applications and corresponding APIs such as, for example, a trade capture application and a trade API may be mapped to facilitate functionalities of the margin models. The mapping may have been accomplished by using the canonical data model consistent with present disclosures. The canonical margin data model may be usable to build distribution API for data flow between the various applications. The canonical margin model may facilitate usage of common terminology amongst the various applications. The canonical margin model may also enable consistent use of entities and columns across different applications as well as automated generation of code based on standardized data models. The standardized entities and columns may provide better visibility for users.

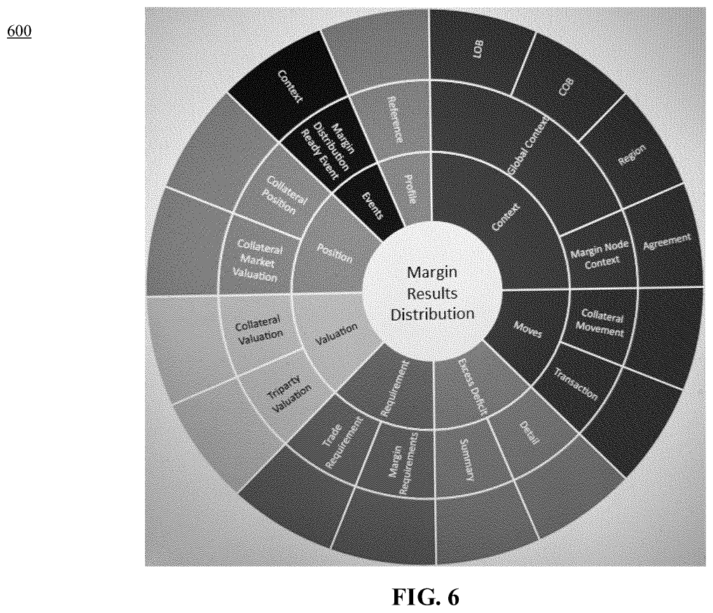

FIG. 6 is a results entity distribution diagram 600 of an exemplary process for implementing a method for providing standardized data models to facilitate automatic generating and mapping of applications in a networked environment. In FIG. 6, result distributions for a machine learning model such as, for example, a margin model is provided.

As illustrated in FIG. 6, the categorization of the result distributions may be visually represented in a color delineated diagram. The diagram may correspond to a circular element which organizes categories and corresponding subcategories as structures radiating from a central point. For example, for a position category, corresponding subcategories relating to collateral positions and collateral market valuations may be provided as emanating from the position category. Additionally, the categories and corresponding subcategories may share a common color to illustrate delineations between various categories.

Accordingly, with this technology, an optimized process for providing standardized data models to facilitate automatic generating and mapping of applications in a networked environment is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing a canonical data model, the method being implemented by at least one processor, the method comprising:
receiving, by the at least one processor via a graphical user interface, at least one request to generate at least one model, the at least one request including configuration data for the at least one model;
identifying, by the at least one processor, the canonical data model that corresponds to the at least one model, the canonical data model including at least one parameter;
automatically mapping, by the at least one processor, the configuration data to the at least one parameter;
automatically generating, by the at least one processor, the at least one model based on a result of the mapping; and
outputting, by the at least one processor, the at least one model in response to the at least one request.

2. The method of claim 1, wherein the canonical data model relates to a predetermined data model that includes a standardized mapping of a plurality of entities and columns for a plurality of network components, the plurality of network components including at least one application and at least one application programming interface.

3. The method of claim 1, wherein, prior to identifying the canonical data model, the method further comprises:
determining, by the at least one processor using the configuration data, whether the requested at least one model corresponds to a previously generated concept; and
identifying, by the at least one processor, the canonical data model when the requested at least one model does not correspond to the previously generated concept.

4. The method of claim 3, further comprising:
identifying, by the at least one processor, a previously generated model that corresponds to the previously generated concept when the requested at least one model corresponds to the previously generated concept; and
outputting, by the at least one processor, the previously generated model in response to the at least one request.

5. The method of claim 1, wherein automatically mapping the configuration data further comprises:
categorizing, by the at least one processor, at least one business context in the configuration data based on the at least one parameter; and
determining, by the at least one processor, at least one downstream feed for the at least one model based on the at least one parameter.

6. The method of claim 5, wherein the at least one parameter includes standardized terminology for categorizing the at least one business context in the configuration data.

7. The method of claim 5, further comprising:
determining, by the at least one processor, at least one standard application programming interface configuration for the at least one model based on the at least one parameter; and
determining, by the at least one processor, at least one standard integration configuration for the at least one model based on the at least one parameter.

8. The method of claim 1, wherein automatically generating the at least one model further comprises:
automatically generating, by the at least one processor, software code for the at least one model based on the result of the mapping,
wherein the automatically generated software code is operable in a networked environment to access data and to forecast at least one outcome based on the accessed data.

9. The method of claim 1, wherein the at least one model includes at least one from among a machine learning model, a mathematical model, a process model, and a data model.

10. A computing device configured to implement an execution of a method for providing a canonical data model, the computing device comprising:
a processor;
a memory; and
a communication interface coupled to each of the processor and the memory, wherein the processor is configured to:
receive, via a graphical user interface, at least one request to generate at least one model, the at least one request including configuration data for the at least one model;
identify the canonical data model that corresponds to the at least one model, the canonical data model including at least one parameter;
automatically map the configuration data to the at least one parameter;
automatically generate the at least one model based on a result of the mapping; and
output the at least one model in response to the at least one request.

11. The computing device of claim 10, wherein the canonical data model relates to a predetermined data model that includes a standardized mapping of a plurality of entities and columns for a plurality of network components, the plurality of network components including at least one application and at least one application programming interface.

12. The computing device of claim 10, wherein, prior to identifying the canonical data model, the processor is further configured to:
determine, by using the configuration data, whether the requested at least one model corresponds to a previously generated concept; and
identify the canonical data model when the requested at least one model does not correspond to the previously generated concept.

13. The computing device of claim 12, wherein the processor is further configured to:
identify a previously generated model that corresponds to the previously generated concept when the requested at least one model corresponds to the previously generated concept; and
output the previously generated model in response to the at least one request.

14. The computing device of claim 10, wherein, to automatically map the configuration data, the processor is further configured to:
categorize at least one business context in the configuration data based on the at least one parameter; and
determine at least one downstream feed for the at least one model based on the at least one parameter.

15. The computing device of claim 14, wherein the at least one parameter includes standardized terminology for categorizing the at least one business context in the configuration data.

16. The computing device of claim 14, wherein the processor is further configured to:
determine at least one standard application programming interface configuration for the at least one model based on the at least one parameter; and
determine at least one standard integration configuration for the at least one model based on the at least one parameter.

17. The computing device of claim 10, wherein, to automatically generate the at least one model, the processor is further configured to:
automatically generate software code for the at least one model based on the result of the mapping,
wherein the automatically generated software code is operable in a networked environment to access data and to forecast at least one outcome based on the accessed data.

18. The computing device of claim 10, wherein the at least one model includes at least one from among a machine learning model, a mathematical model, a process model, and a data model.

19. A non-transitory computer readable storage medium storing instructions for providing a canonical data model, the storage medium comprising executable code which, when executed by a processor, causes the processor to:
receive, via a graphical user interface, at least one request to generate at least one model, the at least one request including configuration data for the at least one model;
identify the canonical data model that corresponds to the at least one model, the canonical data model including at least one parameter;
automatically map the configuration data to the at least one parameter;
automatically generate the at least one model based on a result of the mapping; and
output the at least one model in response to the at least one request.

20. The storage medium of claim 19, wherein the canonical data model relates to a predetermined data model that includes a standardized mapping of a plurality of entities and columns for a plurality of network components, the plurality of network components including at least one application and at least one application programming interface.
